(19) United States
(12) Patent Application Publication
(10) Pub. No.: US 2025/0224134 A1
(43) Pub. Date: Jul. 10, 2025

(54) PASSIVE ENERGY RECOVERY VENTILATOR

(71) Applicant: RenewAire, LLC, Waunakee, WI (US)

(72) Inventor: Ryan Marks, Waunakee, WI (US)

(21) Appl. No.: 19/012,305

(22) Filed: Jan. 7, 2025

Related U.S. Application Data
(60) Provisional application No. 63/619,112, filed on Jan. 9, 2024.

(51) Int. Cl. F24F 12/00; F24F 13/28

(52) U.S. Cl. CPC F24F 12/006; F24F 13/28

(57) ABSTRACT

An energy recovery ventilator system includes a heat exchanger assembly and a housing connected to the heat exchanger assembly. The housing mounts directly to a cold air return of a structure such that the energy recovery ventilator system is positioned between a blower intake of a primary HVAC system and the cold air return. The energy recovery ventilator system is passive such that air flow through the system results from a fan of the primary HVAC system.

### CROSS-REFERENCE TO RELATED APPLICATION

The present application claims the priority benefit of U.S. Provisional Patent App. No. 63/619,112 filed on Jan. 9, 2024, the entire disclosure of which is incorporated by reference herein.

### BACKGROUND

An energy recovery ventilator (ERV) refers to a system that treats air flowing into and out of a structure. Specifically, an ERV is used to manage the heat and the moisture of air that is entering a structure and exiting the structure. The specific air management that is performed depends on the outdoor air temperature (relative to indoor temperature) and the outdoor air humidity (relative to indoor humidity). Traditional ERVs utilize two or more fans to create independent air streams. For example, a first fan of the ERV is used to pull outdoor air into the structure, and a second fan of the ERV is used to expel indoor air back to the outside.

### SUMMARY

An illustrative energy recovery ventilator system includes a heat exchanger assembly and a housing connected to the heat exchanger assembly. The housing mounts directly to a cold air return of a structure such that the energy recovery ventilator system is positioned between a blower intake of a primary HVAC system and the cold air return. The energy recovery ventilator system is passive such that air flow through the system results from a fan of the primary HVAC system.

In one embodiment, the housing includes a filter for the primary HVAC system, and air flow through the cold air return goes through the energy recovery ventilator system and the filter prior to entering the primary HVAC system. In another embodiment, the filter is sized to create a positive pressure within the structure. In another embodiment, the system includes a first duct that receives outside fresh air that enters the structure. The system can also include a second duct that receives supply air for the primary HVAC system. The system can further include a third duct that receives exhaust air that is leaving the structure after travelling through the heat exchanger assembly.

In another embodiment, an interlace manifold is mounted to a side of the heat exchanger assembly. The interlace manifold includes a plurality of air streams at different temperatures to maximize a net temperature delta across the heat exchanger assembly. In one embodiment, the heat exchanger assembly includes a first side and a second side that is opposite the first side, where the first side includes a pair of ducts, and where the interlace manifold is mounted to the second side opposite the pair of ducts. In an illustrative embodiment, the interlace manifold converts the heat exchanger assembly from a standard cross flow heat exchanger into a hybrid counter flow heat exchanger.

An illustrative method of making an energy recovery ventilator system includes forming a heat exchanger assembly and connecting a housing to the heat exchanger assembly. The method also includes mounting the housing directly to a cold air return of a structure such that the energy recovery ventilator system is positioned between a blower intake of a primary HVAC system and the cold air return. As a result, the energy recovery ventilator system is passive such that air flow through the system results from a fan of the primary HVAC system.

In one embodiment, the method includes mounting a filter in the housing for the primary HVAC system, where air flow through the cold air return goes through the energy recovery ventilator system and the filter prior to entering the primary HVAC system. In another embodiment, the filter is sized to create a positive pressure within the structure. In another embodiment, the method includes forming a first duct that receives outside fresh air that enters the structure. The method can also include forming a second duct that receives supply air for the primary HVAC system, and forming a third duct that receives exhaust air that is leaving the structure after travelling through the heat exchanger assembly.

In one embodiment, the method includes mounting an interlace manifold to a side of the heat exchanger assembly. The interlace manifold includes a plurality of air streams at different temperatures to maximize a net temperature delta across the heat exchanger assembly. In another embodiment, the heat exchanger assembly includes a first side and a second side that is opposite the first side, where the first side includes a pair of ducts, and where the method includes mounting the interlace manifold to the second side opposite the pair of ducts. In an illustrative embodiment, mounting the interlace manifold converts the heat exchanger assembly from a standard cross flow heat exchanger into a hybrid counter flow heat exchanger.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A is a perspective view of a passive ERV system in accordance with an illustrative embodiment.

FIG. 1B is an exploded view of the passive ERV system in accordance with an illustrative embodiment.

FIG. 2 depicts the passive ERV system mounted to a primary system in accordance with an illustrative embodiment.

FIG. 3A is a first side view of a passive ERV system mounted to a furnace in accordance with an illustrative embodiment.

FIG. 3B is a second side view of the passive ERV system mounted to the furnace in accordance with an illustrative embodiment.

### DETAILED DESCRIPTION

Traditional energy recovery ventilator (ERV) systems include a plurality of dedicated fans to facilitate air circulation through the ERV. For example, a first dedicated fan is used to draw outside air into a structure in/on which the ERV is mounted. The air drawn in via the first fan is forced through a heat exchanger that either adds or removes heat from the air. A second dedicated fan of the ERV system is used to pull stale/used air from the structure to the outside environment. Typically, in the summer when outdoor temperatures are warmer than indoor temperatures, the heat exchanger removes heat from the outside air. Similarly, in the winter months when outdoor temperatures are colder than indoor temperatures, the heat exchanger adds heat to the outside air. An ERV can also be used to control humidity in the air by mixing different air streams to transfer water vapor from one air stream to another. The pre-treated air enters into a furnace, air conditioning unit, or other system that is used for climate control within the structure.

The use of dedicated fans by an ERV system adds complexity to the system, increases cost, and requires additional electrical connection(s) to run the fans. Described herein is a passive ERV system that utilizes the blower system (e.g., fan(s)) of the furnace, air conditioning unit, or other primary climate control system in the structure to force air through a heat exchanger and an air interface manifold. The heat exchanger can be any mechanism that transfers heat in the form of either latent heat or sensible heat. The primary system can be any heating, cooling, or drying system that is principally used to heat, cool, or dry a structure. The blower system of the primary system can refer to any component(s) that move air through the structure via a mechanical pressure differential that is driven by an energy source. The air interface manifold provides cross-counter air routing, as described in more detail below. In an illustrative embodiment, the proposed ERV system mounts directly onto the primary system within the structure such that the blower system of the primary system is able to move air through the ERV. As a result, the proposed ERV system is passive and does not require dedicated fans or blowers to operate.

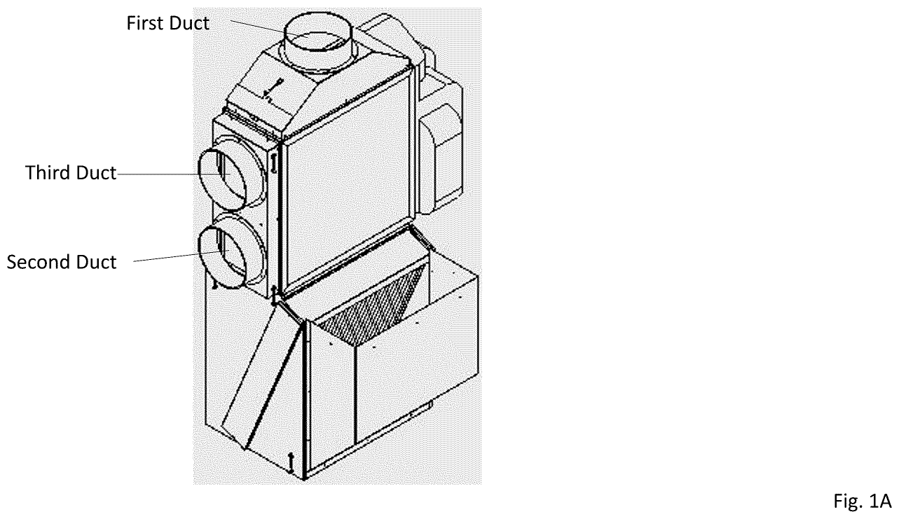

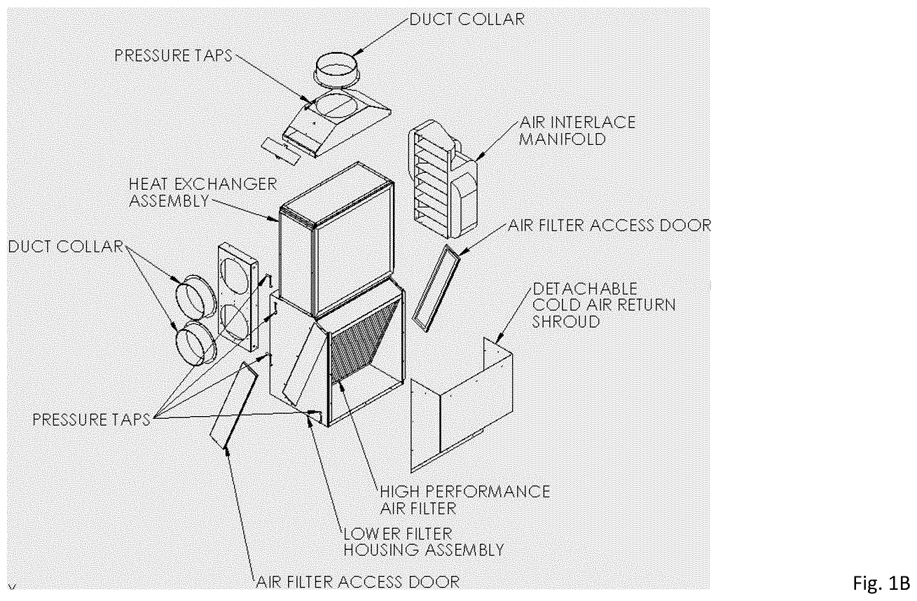

FIG. 1A is a perspective view of a passive ERV system in accordance with an illustrative embodiment. FIG. 1B is an exploded view of the passive ERV system in accordance with an illustrative embodiment. In another illustrative embodiment, the passive ERV includes ducting such that the passive ERV is a balanced ventilation apparatus, which refers to a system that allows fresh air to be brought inside a structure while simultaneously allowing existing (i.e., used) air to leave the structure. As shown, the passive ERV system includes 3 ducts, and associated duct housings and duct collars that mount to a heat exchanger assembly. A first duct is positioned at a top of the passive ERV system. A second duct is on a side of the passive ERV system, and a third duct is also on the side of the passive ERV system, positioned above the second duct. It is to be understood that in alternative embodiments, the duct placement about the passive ERV system may be different. In an illustrative embodiment, the first duct receives outside fresh air that is entering the structure. The second duct receives supply air for the primary system, and the third duct receives exhaust air that is leaving the structure after going through the heat exchanger assembly.

As also shown in FIG. 1B, the passive ERV system also includes a cold air return and uses a high performance air filter to filter air that is received via the cold air return. In an illustrative embodiment, the filter is sized to provide a positive pressure within the structure. The cold air return includes a lower filter housing assembly, and a detachable cold air return shroud that mounts to the lower filter housing assembly. Air filter access doors provide access for changing the filter, and are positioned on two sides of the lower filter housing assembly. In addition to filtering, the high performance filter also creates air resistance that causes a pressure differential to generate air flow. In an illustrative embodiment, the cold air return and/or any of the ducts of the passive ERV system can include dampers, baffles, actuators, etc. to independently turn on/off air streams to enhance/restrict the flow of air at each of the ducts/return. In another illustrative embodiment, the structural components of the passive ERV system can be made from metal such as aluminum. Alternatively, a different material may be used such as plastic, carbon, etc.

The passive ERV system also includes an air interlace manifold mounted to a side of the heat exchanger assembly (i.e., on a side of the heat exchanger assembly that is opposite the second and third ducts. In alternative embodiments, the positions of the air interlace manifold and the second and third ducts can be reversed. The air interlace manifold is used to turn a standard cross flow heat exchanger into a hybrid counter flow heat exchanger. This is done by stacking different temperature air streams to ensure that the largest net temperature delta exists across the entire heat exchanger, which helps drive higher overall energy recovery efficiency.

The ERV system also includes a number of pressure taps that are used to monitor and commission the device. Depending on length of ducts and operating pressure of the existing system, an accessory booster fan may or may not be utilized to achieve desired airflow. Conversely in applications where flow is too high, a damper may need to be installed to restrict airflow. The pressure taps allow an individual to measure airflow across the heat exchanger and monitor filter cleanliness.

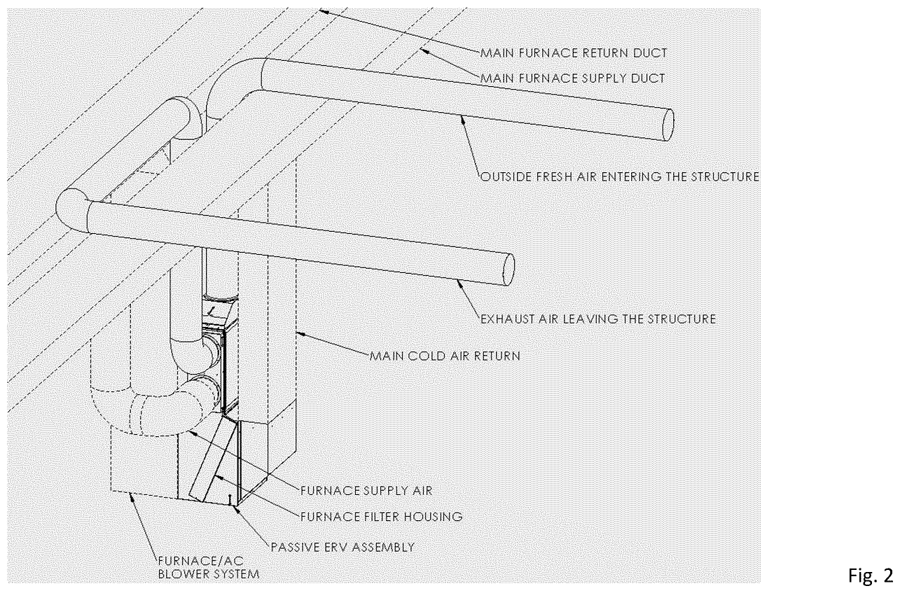

FIG. 2 depicts the passive ERV system mounted to a primary system in accordance with an illustrative embodiment. The primary system includes a blower system that is used to circulate air through the passive ERV system. As shown, the passive ERV system is mounted between the blower intake of the primary system and the cold air return for the structure, such that air flow through the cold air return passes through the passive ERV and its filter prior to entering the primary system. Thus, in an illustrative embodiment, the passive ERV system mounts directly to and essentially forms the cold air return port of the primary system.

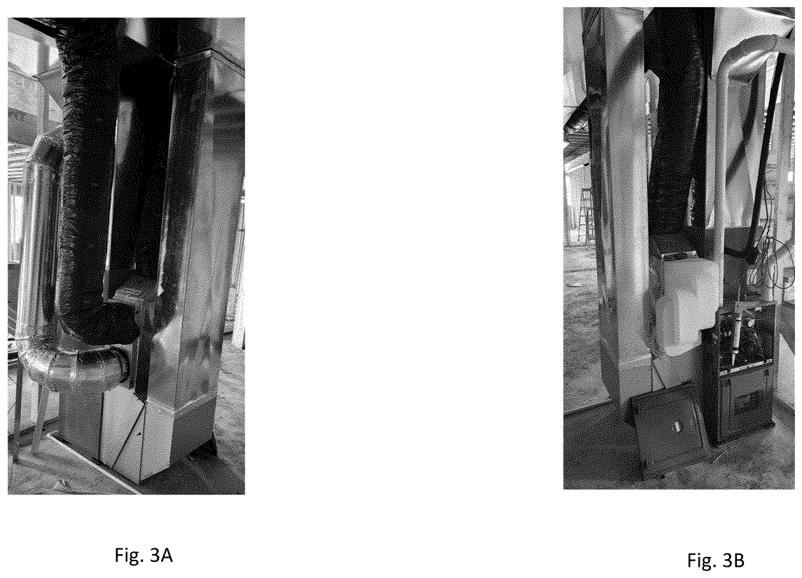

FIG. 2 also depicts ductwork mounted to and extending away from the ducts of the passive ERV system. The ductwork for the main cold air return of the structure mounts directly to the detachable cold air return shroud of the ERV system. Fresh air ductwork (to receive outside fresh air that enters the structure) is mounted to the first duct (see FIG. 1A) of the passive ERV system. Primary system (e.g., furnace) supply air ductwork mounts to the second duct of the passive ERV system, and exhaust air ductwork for air leaving the structure mounts to the third duct of the passive ERV system. FIG. 3A is a first side view of a passive ERV system mounted to a furnace in accordance with an illustrative embodiment. FIG. 3B is a second side view of the passive ERV system mounted to the furnace in accordance with an illustrative embodiment. As discussed herein, in alternative embodiments, instead of a furnace the primary system can be an air conditioning system, a drying system, or any other climate control system with air flow.

In an illustrative embodiment, the proposed passive ERV system is a balanced ventilation apparatus that provides heat energy recovery via a heat exchanger and operates in conjunction with a blower system of a primary system in the structure. In another embodiment, the passive ERV system is not able to operate on its own independently because the system depends on the blower system of the primary system to facilitate air movement.

In another embodiment, the proposed passive ERV system recovers heat energy that follows an air flow path of outdoor air flowing through the heat exchanger into the return air path, inline of the primary system return and subsequently the intake of the blower system. At the same time, air from the blower system is moving air into the primary system supply air stream that flows through the heat exchanger into the exhaust air stream. In an illustrative embodiment, the passive ERV system inserts air from the outdoor air stream (after it has flowed through the heat exchanger) into the blower system prior to the fan but after the primary filtration. More specifically, upon activation of the blower system, a pressure difference is created (due to the ERV filter) that pulls air from the outdoor air stream through the heat exchanger into supply air stream and eventually the blower intake. Similarly, when the blower system is activated, a pressure difference is created that pushes air into the return air stream through the heat exchanger into the exhaust air stream and eventually outside of the structure.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. An energy recovery ventilator system comprising:
a heat exchanger assembly;
a housing connected to the heat exchanger assembly, wherein the housing mounts directly to a cold air return of a structure such that the energy recovery ventilator system is positioned between a blower intake of a primary HVAC system and the cold air return; and
wherein the energy recovery ventilator system is passive such that air flow through the system results from a fan of the primary HVAC system.

2. The system of claim 1, wherein the housing includes a filter for the primary HVAC system, and wherein air flow through the cold air return goes through the energy recovery ventilator system and the filter prior to entering the primary HVAC system.

3. The system of claim 2, wherein the filter is sized to create a positive pressure within the structure.

4. The system of claim 1, further comprising a first duct that receives outside fresh air that enters the structure.

5. The system of claim 4, further comprising a second duct that receives supply air for the primary HVAC system.

6. The system of claim 5, further comprising a third duct that receives exhaust air that is leaving the structure after travelling through the heat exchanger assembly.

7. The system of claim 1, further comprising an interlace manifold mounted to a side of the heat exchanger assembly.

8. The system of claim 7, wherein the interlace manifold includes a plurality of air streams at different temperatures to maximize a net temperature delta across the heat exchanger assembly.

9. The system of claim 7, wherein the heat exchanger assembly includes a first side and a second side that is opposite the first side, wherein the first side includes a pair of ducts, and wherein the interlace manifold is mounted to the second side opposite the pair of ducts.

10. The system of claim 7, wherein the interlace manifold converts the heat exchanger assembly from a standard cross flow heat exchanger into a hybrid counter flow heat exchanger.

11. A method of making an energy recovery ventilator system, the method comprising:
forming a heat exchanger assembly;
connecting a housing to the heat exchanger assembly;
mounting the housing directly to a cold air return of a structure such that the energy recovery ventilator system is positioned between a blower intake of a primary HVAC system and the cold air return; and
wherein the energy recovery ventilator system is passive such that air flow through the system results from a fan of the primary HVAC system.

12. The method of claim 11, further comprising mounting a filter in the housing for the primary HVAC system, wherein air flow through the cold air return goes through the energy recovery ventilator system and the filter prior to entering the primary HVAC system.

13. The method of claim 12, wherein the filter is sized to create a positive pressure within the structure.

14. The method of claim 11, further comprising forming a first duct that receives outside fresh air that enters the structure.

15. The method of claim 14, further comprising forming a second duct that receives supply air for the primary HVAC system.

16. The method of claim 15, further comprising forming a third duct that receives exhaust air that is leaving the structure after travelling through the heat exchanger assembly.

17. The method of claim 11, further comprising mounting an interlace manifold to a side of the heat exchanger assembly.

18. The method of claim 17, wherein the interlace manifold includes a plurality of air streams at different temperatures to maximize a net temperature delta across the heat exchanger assembly.

19. The method of claim 17, wherein the heat exchanger assembly includes a first side and a second side that is opposite the first side, wherein the first side includes a pair of ducts, and further comprising mounting the interlace manifold to the second side opposite the pair of ducts.

20. The method of claim 17, wherein mounting the interlace manifold converts the heat exchanger assembly from a standard cross flow heat exchanger into a hybrid counter flow heat exchanger.
